(19) United States
(12) Patent Application Publication
(10) Pub. No.: US 2014/0158942 A1
(43) Pub. Date: Jun. 12, 2014

(54) WATER-GAS SHIFT CATALYST

(71) Applicants: Peter Edward James Abbott, Cleveland (GB); Martin Fowles, North Yorkshire (GB); Antonio Chica Lara, Valencia (ES); Norman Macleod, Tyne and Wear (GB); Juan Jose Gonzalez Perez, Valencia (ES); Elaine Margaret Vass, County Durham (GB)

(72) Inventors: Peter Edward James Abbott, Cleveland (GB); Martin Fowles, North Yorkshire (GB); Antonio Chica Lara, Valencia (ES); Norman Macleod, Tyne and Wear (GB); Juan Jose Gonzalez Perez, Valencia (ES); Elaine Margaret Vass, County Durham (GB)

(73) Assignee: Johnson Matthey Public Limited Company, London (GB)

(21) Appl. No.: 14/123,809

(22) PCT Filed: May 22, 2012
(86) PCT No.: PCT/GB2012/051157

§ 371 Date: Jan. 10, 2014

(30) Foreign Application Priority Data
Jun. 6, 2011 (GB) 1109376.2

(51) Int. Cl. B01J 23/887; C01B 3/16

(52) U.S. Cl. CPC B01J 23/8872; C01B 3/16
USPC 252/373; 502/309

(57) ABSTRACT

A catalyst precursor for preparing a catalyst suitable for use in a sour water-gas shift process is described, including; 5 to 30% by weight of a catalytically active metal oxide selected from tungsten oxide and molybdenum oxide; 1 to 10% by weight of a promoter metal oxide selected from cobalt oxide and nickel oxide; and 1 to 15% by weight of an oxide of an alkali metal selected from sodium, potassium and caesium; supported on a titania catalyst support.

This invention relates to catalysts suitable for use in a sour water-gas shift process.

The water-gas shift process is used to adjust the hydrogen content of a synthesis gas. Synthesis gas, also termed syngas, may be generated by gasification of carbonaceous feedstocks such as coal, petroleum coke or other carbon-rich feedstocks using oxygen or air and steam at elevated temperature and pressure. To achieve a gas stoichiometry suitable for the production of methanol or hydrocarbons, or to produce hydrogen for the production of ammonia or power, the gas composition has to be adjusted by increasing the hydrogen content. This is achieved by passing the raw synthesis gas, in the presence of steam, over a suitable water gas shift catalyst at elevated temperature and pressure. The synthesis gas generally contains one or more sulphur compounds and so must be processed using sulphur-resistant catalysts, known as “sour shift” catalysts. The reaction may be depicted as follows;

H₂O+CO [symbol] H₂+CO₂

This reaction is exothermic, and conventionally it has been allowed to run adiabatically, i.e. without applied cooling, with control of the exit temperature governed by feed gas inlet temperature, composition and by by-passing some of the synthesis gas around the reactor.

Undesirable side reactions, particularly methanation, can occur over conventional catalysts at temperatures over 400° C. To avoid this, the shift reaction requires considerable amounts of steam to be added to prevent a runaway and ensure the desired synthesis gas composition is obtained with minimum formation of additional methane. The costs of generating steam can be considerable and therefore there is a desire to reduce this where possible.

Conventional catalysts, such as KATALCO_{JM}™ K8-11, generally consist of sulphided cobalt and molybdenum supported on a support comprising magnesia and alumina. Such catalysts are described in U.S. Pat. No. 3,529,935. The catalyst is typically provided to the end-user in oxidic form and sulphided in situ to generate the active form. Alternatively a pre-activated sulphided catalyst may be provided, although these can be more difficult to handle.

We have devised a catalyst that produces reduced levels of methanation and so is useful in low-steam:CO water gas shift processes.

Accordingly, the invention provides a catalyst precursor for preparing a catalyst suitable for use in a sour water-gas shift process, comprising; 5 to 30% by weight of a catalytically active metal oxide selected from tungsten oxide and molybdenum oxide; 1 to 10% by weight of a promoter metal oxide selected from cobalt oxide and nickel oxide; and 1 to 15% by weight of an oxide of an alkali metal selected from sodium, potassium and caesium; supported on a titania catalyst support.

The invention further provides a catalyst comprising the sulphided catalyst precursor, methods of preparing the catalyst precursor and the catalyst, and a water gas shift process using the catalyst.

We have found that surprisingly the combination of alkali metal and titania catalyst support reduces the methanation side reaction.

The catalytically active metal oxide may be tungsten oxide or molybdenum oxide and is present in an amount in the range 5 to 30% by weight, preferably 5 to 15% by weight, more preferably 5 to 10% by weight. The catalytically active metal oxide is preferably molybdenum oxide.

The promoter metal oxide may be nickel oxide or a cobalt oxide and is present in an amount in the range 1 to 10% by weight, preferably 2 to 7% by weight. The promoter metal oxide is preferably a cobalt oxide. Cobalt oxide may be present as CoO or Co₃O₄. Whichever cobalt oxide is present, the amount present in the catalyst precursor herein is expressed as CoO.

The catalyst precursor further comprises an oxide of an alkali metal selected from sodium, potassium or caesium at an amount in the range 1 to 15% by weight, preferably 5 to 15% by weight. Preferably the alkali metal oxide is potassium oxide.

The catalytically active metal oxide, promoter metal oxide and alkali metal oxide are supported on a titania catalyst support. By “titania catalyst support” we mean that the catalytically active metal oxide, promoter metal oxide and alkali metal oxide are disposed on a titania surface. Preferably ≧85% wt, more preferably ≧90% wt, most preferably ≧95% wt and especially ≧99% wt or essentially all of the catalytically active metal oxide, promoter metal oxide and alkali metal oxide are disposed on a titania surface. Accordingly, the titania support may be a bulk titania support or a titania coated support.

Preferably the catalyst precursor consists essentially of the catalytically active metal oxide, promoter metal oxide and alkali metal oxide supported on the titania catalyst support.

Bulk titania supports, which comprise titania throughout the support, may be in the form of a powder or a shaped unit such as a shaped pellet or extrudate, which may be lobed or fluted. Suitable powdered titanias typically have particles of surface weighted mean diameter D[3,2] in the range 1 to 100 μm, particularly 3 to 100 μm. If desired, the particle size may be increased by slurrying the titania in water and spray drying. Preferably the BET surface area is in the range 10 to 500 m²/g. Bulk titania powders may be used to fabricate shaped pellets or extrudates or may be used to prepare titania-containing wash-coats that may be applied to catalyst support structures. Shaped titania supports may have a variety of shapes and particle sizes, depending upon the mould or die used in their manufacture. For example the shaped titania support may have a cross-sectional shape which is circular, lobed or other shape and may have a width in the range 1 to 15 mm and a length from about 1 to 15 mm. The surface area may be in the range 10 to 500 m²/g, and is preferably 50 to 400 m²/g. The pore volume of the titania may be in the range 0.1 to 4 ml/g, preferably 0.2 to 2 ml/g and the mean pore diameter is preferably in the range from 2 to about 30 nm. The bulk titania support may comprise another refractory oxide material, however preferably the bulk titania catalyst support comprises ≧85% wt titania, more preferably ≧90% wt titania, most preferably ≧95% wt titania and especially ≧99% wt titania. The titania may be amorphous or in the anatase or rutile forms. Preferably the titania is predominantly an anatase titania due to its superior properties as a catalyst support. Suitable bulk titania catalyst supports include P25 titania powder available from Evonik-Degussa, which has a reported ratio of anatase, rutile and amorphous phases of about 78:14:8.

The titania catalyst support may be a precipitated support material prepared by precipitating a titanium compound with an alkali metal compound, optionally washing the precipitate with water to remove alkali metal compounds, drying and calcining the washed material. The resulting titania material may be used as a powder or shaped using conventional techniques. We have found that precipitated titanias have particularly suitable properties as a catalyst support for the catalyst precursor.

In an alternative embodiment, the titania is present as a coating on a core material. Thus titania-coated supports may comprise 2 to 40% wt, preferably 5 to 30% wt, more preferably 5 to 20% wt, and particularly 4-10% wt titania as a surface layer on a core material. The core material may be any suitable catalyst support structure such as a structured packing, a monolith, a shaped pellet or extrudate, or a powder. Titania-coated powders may be used to fabricate shaped units such as extrudates or pellets or may be used to prepare wash coats that may be applied to catalyst support structures. Suitable core materials include metals, ceramics, refractory oxides and other inert solids. Depending upon the desired properties and the form of the titania coating, the core material used may be porous or non-porous. Porous core materials are preferred where the titania coating is formed by impregnation or precipitation of a titanium compound onto the support followed by conversion of the titanium compounds into titania, whereas non-porous materials may be used when the titania coating is formed by wash coating the core material with a titania-containing slurry.

Suitable porous core materials are those with sufficient hydrothermal stability for the water-gas shift process and include alumina, hydrated alumina, silica, magnesia and zirconia support materials and mixtures thereof. Aluminas, hydrated aluminas and magnesium aluminate spinels are preferred. Particularly preferred aluminas are transition aluminas. The transition alumina may be of the gamma-alumina group, for example an eta-alumina or chi-alumina. Alternatively, the transition alumina may be of the delta-alumina group, which includes the high temperature forms such as delta- and theta-aluminas. The transition alumina preferably comprises gamma alumina and/or a delta alumina with a BET surface area in the range 120 to 160 m²/g.

The particle sizes, surface areas and porosities of the titania-coated supports may be derived from the core material. Thus, powdered titania-coated supports formed from porous core materials may have a surface weighted mean diameter D[3,2] in the range 1 to 200 μm, particularly 5 to 100 μm and a BET surface area in the range 50 to 500 m²/g. Shaped titania-coated supports formed from porous core materials may have a cross-sectional shape which is circular, lobed or other shape and may have a width in the range 1-15 mm and a length from about 1 to 15 mm. The surface area may be in the range 10 to 500 m²/g, and is preferably 100 to 400 m²/g. The pore volume of the titania-coated supports made using porous core materials may be in the range 0.1 to 4 ml/g, but is preferably 0.3 to 2 ml/g and the mean pore diameter is preferably in the range from 2 to about 30 nm.

Suitable non-porous core materials are ceramics such as certain spinels or perovskites as well as alpha alumina or metal catalyst supports including suitable modified steel support materials such as Fecralloy™.

The catalyst precursor may be provided as a structured packing or a monolith such as a honeycomb or foam, but is preferably in the form of a shaped unit such as a pellet or extrudate. Monoliths, pellets and extrudates may be prepared from powdered materials using conventional methods. Alternatively, where the titania catalyst support is a powder, it may be used to generate a catalyst precursor powder or shaped if desired by pelleting or extrusion before treatment with the catalytically active metal, promoter metal and alkali metal. Where powdered catalyst supports or catalyst precursors are shaped it will be understood that the resulting shaped catalyst precursor may additionally comprise minor amounts, e.g. 0.1 to 5% wt in total, of forming aids such as a lubricant and/or binder. Similarly, where wash-coated titania is present, there may additionally be minor amounts, e.g. 0.1 to 5% wt in total, of wash-coating additives.

The catalyst precursor is sulphided to provide the active catalyst. Accordingly, the invention further provides a catalyst comprising a sulphided catalyst precursor as described herein in which at least a portion of the catalytically active metal is in the form of one or more metal sulphides.

The catalyst precursor may be made by a number of routes. In one embodiment, the precursor is made by an impregnation process in which a titania catalyst support is impregnated with compounds of the catalytically active metal, promoter metal and alkali metal and the compounds heated to convert them to the corresponding oxides. We have found that a two-step procedure whereby the alkali-metal oxide is formed in a second step after deposition of the catalytically active metal oxide and promoter metal oxide is advantageous.

Accordingly the invention provides a method of preparing the catalyst precursor comprising the steps of; (i) impregnating a titania catalyst support with a solution comprising a catalytically active metal compound selected from compounds of tungsten and molybdenum and a promoter metal compound selected from compounds of cobalt and nickel, (ii) drying and optionally calcining the impregnated titania support to form a first material, (iii) impregnating the first material with a solution of an alkali metal compound selected from compounds of sodium, potassium and caesium, and (iv) drying and calcining the impregnated material to form a calcined second material.

The first impregnation step (i) can be carried out using either co-impregnation or sequential impregnation of catalytically active metal and promoter metal.

The titania catalyst support may be a commercially available titania catalyst support.

Alternatively, as stated above, the titania catalyst support may be prepared by precipitating a titanium compound with an alkali metal compound, washing the precipitate with water to remove alkali metal compounds, drying and calcining the washed material. For this, the calcination may be performed at a temperature in the range 350-550° C., preferably 400-550° C., more preferably 450-550° C. The calcination time may be between 1 and 8 hours. The titanium compounds may be selected from chlorides, sulphates, citrates, lactates oxalates, and alkoxides (e.g. ethoxides, propoxides and butoxides), and mixtures thereof. For example, one suitable titanium compound is a commercially available solution of TiCl₃ in hydrochloric acid. The alkaline precipitant may be selected from the hydroxide, carbonate or hydrogen carbonate of sodium or potassium, or mixtures of these. Alternatively ammonium hydroxide or an organic base may be used.

Alternatively, as stated above, the titania catalyst support may be a titania coated support. The titania coating may be produced using a number of methods. In one embodiment, the titania layer is formed by impregnation of the surface of a core material with a suitable titanium compound and calcining the impregnated material to convert the titanium compound into titania. Suitable titanium compounds are organo-titanium compounds, such as titanium alkoxides, (e.g. titanium propoxide or titanium butoxide), chelated titanium compounds, and water soluble titanium salts such as acidic titanium chloride salts, titanium lactate salts or titanium citrate salts. The coating and calcination may be repeated until the titania content is at the desired level. Calcination at temperatures in the range 450 to 550° C. is preferred. The calcination time may be between 1 and 8 hours. The thickness of the titania surface layer formed in this way is preferably 1 to 5 monolayers thick. Alternatively the titania coating may be produced by precipitating titanium compounds onto the core material and heating to convert the precipitated material into titania in a manner similar to that described above for the precipitation of bulk titania catalyst supports. Alternatively the titania layer may be applied to the core material using conventional wash-coating techniques in which a slurry of a titania material is applied to the core material. The thickness of the titania surface layer formed in this way may be 10 to 1000 μm thick. In this embodiment, preferably the titania material used to prepare the wash-coat comprises the first material; namely a titania powder onto which the catalytically active metal and promoter metal have been applied and converted into the respective oxides. Subsequent treatment of the dried and calcined wash coat with alkali compounds may then be performed, followed by calcination to form the catalyst precursor.

The compounds of catalytically active metal, promoter metal and alkali metal may be any suitably soluble compounds. Such compounds are preferably water-soluble salts, including but not limited to, metal nitrates and amine complexes. Particularly preferred compounds include cobalt nitrate, ammonium molybdate and potassium nitrate. Complexing agents and dispersion aids well known to those skilled in the art, such as acetic acid, citric acid and oxalic acid, and combinations thereof, may also be used. These agents and aids are typically removed by the calcination steps.

The optional first calcination of the cobalt and molybdenum impregnated titania support to form the first material may be performed at temperatures in the range 300 to 600° C., preferably 350 to 550° C. The calcination time may be between 1 and 8 hours. Including a first calcination step is desirable, particularly when the solvent used for the second impregnation step (iii) may result in dissolution of catalytically active metal and/or promoter metal from the surface of the titania support.

We have found that the second calcination may be used to improve the performance of the catalyst. Therefore preferably the calcination to form the calcined second material is performed at a temperature in the range 450 to 800° C., preferably 475 to 600° C., more preferably 475 to 525° C. The calcination time may be between 1 and 8 hours.

Where the calcined second material is a powder, the preparation method preferably further comprises a step of shaping the second calcined material into pellets, extrudates or granules. This is so the resulting catalyst does not adversely effect the pressure drop through the water-gas shift vessel.

The catalyst precursor may be provided to the water-gas shift vessel and sulphided in-situ using a gas mixture containing a suitable sulphiding compound, or may be sulphided ex-situ as part of the catalyst production process. Accordingly, the invention further provides a method of preparing a catalyst comprising the step of sulphiding the catalyst precursor described herein.

Sulphiding may be performed by applying a sulphiding gas stream to the precursor in a suitable vessel. The sulphiding gas stream may be a synthesis gas containing one or more sulphur compounds or may be a blend of hydrogen and nitrogen containing one or more suitable sulphiding compounds. Preferred sulphiding compounds are hydrogen sulphide (H₂S) and carbonyl sulphide (COS). Preferably the sulphiding step is performed with a gas comprising hydrogen sulphide.

The catalyst is useful for catalysing the water gas shift reaction. Accordingly the invention provides a water-gas shift process comprising contacting a synthesis gas comprising hydrogen, steam, carbon monoxide and carbon dioxide and including one or more sulphur compounds, with the catalyst or catalyst precursor described herein.

The synthesis gas may be a synthesis gas derived from steam reforming, partial oxidation, autothermal reforming or a combination thereof. Preferably the synthesis gas is one derived from a gasification process, such as the gasification of coal, petroleum coke or biomass. Such gases may have a carbon monoxide content, depending upon the technology used, in the range 20 to 60 mol %. The synthesis gas requires sufficient steam to allow the water-gas shift reaction to proceed. Synthesis gases derived from gasification processes may be deficient in steam and, if so, steam must be added. The steam may be added by direct injection or by another means such as a saturator or steam stripper. The amount of steam should desirably be controlled such that the total steam:synthesis gas volume ratio in the steam-enriched synthesis gas mixture fed to the catalyst is in the range 0.5:1 to 4:1. The catalysts of the present invention have found particular utility for synthesis gases with a steam:CO ratio in the range 0.5 to 2.5:1, preferably at low steam:CO ratios in the range 0.5 to 1.8:1, more preferably 1.05 to 1.8:1.

The inlet temperature of the shift process may be in the range 220 to 370° C., but is preferably in the range 240 to 350° C. The shift process is preferably operated adiabatically without cooling of the catalyst bed, although if desired some cooling may be applied. The exit temperature from the shift vessel is preferably 500° C., more preferably 475° C. to maximise the life and performance of the catalyst.

The process is preferably operated at elevated pressure in the range 1 to 100 bar abs, more preferably 15 to 65 bar abs.

The water-gas shift reaction converts the CO in the synthesis gas to CO₂. Whereas single once-through arrangements may be used, it may be preferable in some cases to use two or more shift vessels containing the catalyst with temperature control between the vessels and optionally to by-pass a portion of the synthesis gas past the first vessel to the second or downstream vessels. Desirably the shift process is operated such that the product gas mixture has a CO content ≦10% by volume on a dry gas basis, preferably ≦7.5% by volume on a dry gas basis.

The invention may be further described by reference to the following Examples.

### EXAMPLE 1 (COMPARATIVE)

In a first test, a feed gas consisting of 24.0 mol % hydrogen, 41.3 mol % CO, 4.2 mol % CO₂, 1.4 mol % inerts (Ar+N₂) and 29.1 mol % H₂O (corresponding steam:CO ratio 0.70) was passed at 35 barg and at a GHSV of 30,000 Nm³/m³/hr⁻¹ through a bed of crushed KATALCO_{JM} K8-11 sour shift catalyst (0.2-0.4 mm particle size range). Two separate temperatures were employed sequentially for this test, 250° C. and 500° C. The catalyst was pre-sulphided prior to testing in a feed containing 1 mol % H₂S and 10 mol % H₂ in nitrogen.

The steady state CO conversions measured in this test at 250° C. and 500° C. are reported in Table 1, along with the corresponding methane concentration measured at 500° C.

### EXAMPLE 2 (COMPARATIVE)

A titania support was prepared by precipitation of a 1 M solution of TiCl₃ with 1 M NaOH (final pH 9). The resulting precipitate was washed, vacuum filtered, dried and finally calcined at 400° C. for 12 hours in air. The resulting powdered TiO₂ support was subsequently co-impregnated with a solution containing appropriate concentrations of Co(NO₃)₂ and (NH₄)₆Mo₇O₂₄ in order to achieve the target metal loadings. Following impregnation, the resultant catalyst precursor was dried and calcined at 400° C. for 4 hours. The resultant catalyst contained 4 wt % CoO and 8 wt % MoO₃. This catalyst was tested under the same conditions as specified in Example 1. The results obtained are again reported in Table 1.

### EXAMPLE 3

The preparation routed outlined in Example 2 was repeated, with the exception that a further impregnation step was carried out on the calcined catalyst containing Co and Mo. This was done in order to introduce 1 wt % of K₂O promoter. A KNO₃ solution of appropriate concentration was used for this step. Following potassium impregnation, the catalyst was dried and calcined at 400° C. for 4 hours. This catalyst was tested under the conditions specified in Example 1. The results obtained are reported in Table 1.

### EXAMPLE 4

The preparation route outlined in Example 3 was repeated with the exception that the potassium level was increased to 5 wt % K₂O. The resultant catalyst was tested under the conditions specified in Example 1 and the results obtained are reported in Table 1.

### EXAMPLE 5

The preparation route outlined in Example 3 was repeated with the exception that the potassium level was increased to 14 wt % K₂O. The resultant catalyst was tested under the conditions specified in Example 1 and the results obtained are again reported in Table 1.

### EXAMPLE 6

The preparation route outlined in Example 4 was repeated with the exception that the final calcination temperature was increased to 500° C. The resultant catalyst was again tested under the conditions specified in Example 1 and the results obtained are reported in Table 1.

TABLE 1

| | | % CO | % CO | Methane |
|---|---|---|---|---|
| | K₂O loading | conversion | conversion | concentration |
| | (wt %) | 250° C. | 500° C. | (vppm) |
| Example 1 | — | 4.6 | 43.0 | 842 |
| Example 2 | 0 | 19.1 | 50.7 | 907 |
| Example 3 | 1 | 17.0 | 50.3 | 830 |
| Example 4 | 5 | 20.4 | 42.5 | 503 |
| Example 5 | 14 | 23.1 | 41.3 | 127 |
| Example 6 | 5 | 30.5 | 50.8 | 167 |

Based on the above results it is evident that TiO₂ supported CoMo catalyst are highly active for the WGS reaction in the presence of sulphur. However, in the absence of alkali, the rate of methane production is also high under these low steam conditions (Example 2). In order to generate catalyst that are both active and selective (low methane), it is necessary to promote the TiO₂-based catalysts with appropriate amounts of alkali (5-15 wt % potassium oxide).

Furthermore it is observed that calcining a CoMo—K/TiO₂ formulation at the higher temperature of 500° C. (Example 6) further improves both the activity and the selectivity of the catalyst.

### EXAMPLE 7

A titania-coated catalyst support was prepared as follows. The support was prepared by diluting 128 g tetraisopropyl titanate (VERTEC™ TIPT) in 1000 g isopropanol and then mixing with 400 g of a gamma alumina (Puralox™ HP14/150, available from Sasol) at 45° C. for 30 minutes in a rotary evaporator. The isopropanol was then removed by increasing the temperature to 90° C. and applying a vacuum. The resulting particles were calcined at 400° C. for 8 hours after drying at 120° C. for 15 hours. The support contained 5.4% Ti based on the weight of alumina.

### EXAMPLE 8

A titania-coated catalyst support was prepared as follows. 400 g of Puralox™ HP14/150 alumina was mixed with a solution of 138 g of 76% aqueous titanium lactate diluted in 2500 g of deionised water for 30 minutes. The resulting slurry was adjusted to pH 9.5 using 192 g of 14% ammonia solution. The solids were then removed by vacuum filtration, re-slurried in water and washed twice in 2 litres of deionised water. The resulting particles were calcined at 400° C. for 8 hours after drying at 120° C. for 15 hours. The support contained 5.4% Ti based on the weight of alumina.

### EXAMPLE 9 (COMPARATIVE)

In a further test, a feed gas consisting of 5000 ppm of H₂S, 20.6 mol % hydrogen, 35.5 mol % CO, 3.6 mol % CO₂, 1.2 mol % inerts (Ar+N₂) and 39.1 mol % H₂O (corresponding steam:CO ratio 1.1) was passed at 35 barg and at a GHSV of 30,000 Nm³/m³/hr⁻¹ through a bed of crushed KATALCO_{JM} K8-11 sour shift catalyst (0.2-0.4 mm particle size range). The test was carried out at 450° C. and the catalyst was pre-sulphided prior to testing with a feed containing 1 mol % H₂S and 10 mol % H₂ in nitrogen.

The steady state CO conversions measured in this test at 450° C. are reported in Table 2, along with the corresponding methane concentration also at 450° C.

### EXAMPLE 10

A titania-coated catalyst support was prepared by precipitation of TiCl₃ with NaOH (final pH 9) in the presence of an MgO—Al₂O₃ powder. The resulting slurry was washed with demineralised water, vacuum filtered, dried, and then calcination at 500° C. for 4 hours in air. The support contained 38 wt % TiO₂. The resulting powder was impregnated with a solution containing appropriate loadings of Co(NO₃)₂ and (NH₄)₆Mo₇O₂₄ in order to achieve the target metal loadings. Following impregnation, the catalyst precursor was dried and calcined at 500° C. in air for 4 hours.

The impregnation step was repeated with a solution of KNO₃ and calcined at 500° C. for 4 hours. The final catalyst contained 4 wt % CoO, 7 wt % MoO₃ and 5 wt % K₂O. This catalyst was tested under the same conditions as specified in Example 9. The results obtained are reported in Table 2.

### EXAMPLE 11

A commercially available titania powder with a surface area of 50 m²/g was used to prepare catalysts by impregnation with Co(NO₃)₂ and (NH₄)₆Mo₇O₂₄ in order to achieve the target metal loadings. Following impregnation, the resultant catalyst precursor was dried and then calcined at 500° C. for 4 hours. The resulting catalyst contained 4 wt % CoO and 8 wt % MoO₃. The impregnation, drying and calcination steps were repeated using KNO₃ to achieve a loading of 6 wt % K₂O. This catalyst was tested under the same conditions as specified in Example 9 and the results obtained are reported in Table 2.

### EXAMPLE 12

A titania-coated catalyst support was prepared by impregnation of MgO—Al₂O₃ extrudates with a solution of titanium tetra iso-propoxide in n-propanol. The support was dried in air at 105° C. for 4 hours and calcined at 400° C. for 4 hours in air. The final TiO₂ loading was 4.5 wt %. The prepared extrudates were impregnated with Co(NO₃)₂ and (NH₄)₆Mo₇O₂₄ in order to achieve the target metal loadings. The catalyst was dried then calcined at 500° C. for 4 hours in air. A second impregnation was carried out with KNO₃ followed again by drying then calcination at 500° C. for 4 hours in air. The final loadings achieved were 2 wt % CoO, 8 wt % MoO₃ and 5 wt % K₂O. This catalyst was tested under the same conditions as specified in Example 9. The results obtained are reported in Table 2.

TABLE 2

| | | TiO₂ loading | % CO | Methane |
|---|---|---|---|---|
| | K₂O loading | (wt % of | conversion | concentration |
| | (wt %) | support) | 450° C. | (vppm) |
| Example 9 | — | — | 48.3 | 1315 |
| Example 10 | 5 | 38 | 69.9 | 577 |
| Example 11 | 6 | 100 | 72.9 | 504 |
| Example 12 | 5 | 4.5 | 45.0 | 312 |

The results in table 2 show that TiO₂ coated supports and bulk TiO₂ supported catalysts are highly active for the WGS reaction in the presence of sulphur, relative to the base case (KATALCO_{JM} K8-11). The addition of K₂O to TiO₂-containing catalysts is also beneficial in greatly reducing methane formation under the low steam:CO conditions tested.

1-22. (canceled)

23. A catalyst precursor for preparing a catalyst suitable for use in a sour water-gas shift process, comprising;
5 to 30% by weight of a catalytically active metal oxide selected from tungsten oxide and molybdenum oxide;
1 to 10% by weight of a promoter metal oxide selected from cobalt oxide and nickel oxide; and
5 to 15% by weight of an oxide of an alkali metal selected from sodium and potassium;
supported on a titania catalyst support, wherein the titania catalyst support is a bulk titania catalyst support comprising 85% wt titania, or a titania coated catalyst support.

24. A catalyst precursor according to claim 23 wherein the catalytically active metal oxide is molybdenum oxide.

25. A catalyst precursor according to claim 23 wherein the promoter metal oxide is a cobalt oxide.

26. A catalyst precursor according to claim 23 wherein the alkali metal oxide is potassium oxide.

27. A catalyst precursor according to claim 23 wherein the catalytically active metal oxide is present in an amount in the range 5 to 15% by weight.

28. A catalyst precursor according to claim 23 wherein the promoter metal oxide is present in an amount in the range 2 to 7% by weight.

29. A catalyst precursor according to claim 23 wherein the bulk titania catalyst support comprises ≧90% wt titania.

30. A catalyst precursor according to claim 23 wherein the titania coated catalyst support comprises 2 to 40% wt titania as a surface layer on a core material.

31. A catalyst precursor according to claim 30 wherein the core material is a porous support or a non-porous support.

32. A catalyst comprising a sulphided catalyst precursor according to claim 23 in which at least a portion of the catalytically active metal is in the form of one or more metal sulphides.

33. A method of preparing a catalyst precursor according to claim 23 comprising the steps of; (i) impregnating a titania catalyst support with a solution comprising a catalytically active metal compound selected from compounds of tungsten and molybdenum and a promoter metal compound selected from compounds of cobalt and nickel, (ii) drying and optionally calcining the impregnated titania support to form a first material, (iii) impregnating the first material with a solution of an alkali metal compound selected from compounds of sodium and potassium, and (iv) drying and calcining the impregnated material to form a calcined second material.

34. A method according to claim 33 wherein the titania catalyst support is prepared by precipitating a titanium compound with an alkali metal compound, optionally washing the precipitate with water to remove alkali metal compounds, drying and calcining the washed material.

35. A method according to claim 33 wherein the titania catalyst support is prepared by coating the surface of a core material with a titanium compound and heating the coated material to convert the titanium compound to titania.

36. A method according to claim 33 comprising preparing a wash coat of the first material, applying the wash coat to a core material and then drying and calcining the wash coated first material before impregnation with the solution of alkali metal.

37. A method according to claim 33 wherein the calcination to form the calcined second material is performed at a temperature in the range 450-800° C., preferably 475-600° C.

38. A method according to claim 33 wherein when the calcined second material is a powder, further comprising a step of shaping the second calcined material into pellets or extrudates.

39. A method of preparing a catalyst according to claim 32 comprising the step of sulphiding the catalyst precursor with a sulphiding compound.

40. A method according to claim 39 wherein the sulphiding step is performed with a gas comprising hydrogen sulphide.

41. A water-gas shift process comprising contacting a synthesis gas comprising hydrogen, steam, carbon monoxide and carbon dioxide and including one or more sulphur compounds, with a catalyst according to claim 32.

42. A process according to claim 41 wherein the steam to carbon monoxide molar ratio in the synthesis gas is in the range 0.5 to 1.8:1.

43. A catalyst precursor according to claim 23 wherein the catalytically active metal oxide is present in an amount in the range 5 to 10% by weight.

44. A catalyst precursor according to claim 23 wherein the bulk titania catalyst support comprises ≧95% wt titania.
